(19) United States
(12) Patent Application Publication
(10) Pub. No.: US 2011/0107692 A1
(43) Pub. Date: May 12, 2011

(54) Storm shutter assembly

(76) Inventor: Raymond W. Duncan, New Orleans, LA (US)

(21) Appl. No.: 12/590,488

(22) Filed: Nov. 9, 2009

(51) Int. Cl. E06B 3/26

(52) U.S. Cl. 52/202

(57) ABSTRACT

A storm shutter assembly for a building structure has a frame assembly configured for securing around an opening in the building structure. The frame assembly has a top frame member, a bottom frame member coupled to the first frame member, a first side frame member coupled to the top frame member and the second frame member, and a second side frame member coupled to the top frame member and the second frame member opposite said first side frame member. One or more shutter panels are configured for fitting within the frame assembly when the frame assembly is secured to the building around a window or door opening. The shutter panel may be secured by hinges or locks with sliding pins and easily put up or taken down in case of a hurricane or tornado.

### BACKGROUND OF THE INVENTION

This invention relates to window, hurricane and storm shutters, and more particularly to an assembly for installing rectangular shutters intended for security or storm protection and capable of withstanding strong wind conditions such as in a hurricane.

Some of the common approaches to storm protection provide for covering and protecting openings and windows in structures to prevent damage from high winds, rain and flying debris. High winds convert debris into missiles, hitting windows, doors and other openings in a building. Broken windows and doors allow rain, mud, as well as flying debris to enter the structure, which results in further substantial damage, since the force of wind can detach a roof admitting more rain and debris into a building.

Conventionally, plywood sheets are secured in the building openings by screws attached to a window or door frame. Once the danger of hurricane or tornado passes, the plywood sheets need to be taken down and stored until another storm comes. This procedure is time-consuming and may become difficult for persons with diminished physical capacity. Moreover, the tornado warnings may come within minutes of the tornado approaching, which makes this method of building protection ineffective.

As an alternative to the plywood sheets, the construction industry developed various storm shutters that may be permanently secured on a building and be made of metal. Some of such shutters can roll-up, others—expand and contract like an accordion. However, the exterior aesthetics of a building may be adversely affected by roll-up or accordion shutters since traditional home designs do not contemplate provision of these types of coverings for windows or doors.

The present invention contemplates elimination of drawbacks associated with the conventional storm shutter designs and provision of a storm shutter assembly that can be easily installed by a homeowner.

### SUMMARY OF THE INVENTION

It is, therefore, an object of the invention to provide a storm shutter assembly that is inexpensive to manufacture and easy to install.

It is another object of the invention to provide a storm shutter assembly that allows traditional size shutters to be hingedly secured in the building openings.

These and other objects of the invention are achieved through a provision of A storm shutter assembly for a building structure has a frame assembly configured for securing around an opening in the building structure. The frame assembly has a top frame member, a bottom frame member coupled to the first frame member, a first side frame member coupled to the top frame member and the second frame member, and a second side frame member coupled to the top frame member and the second frame member opposite said first side frame member. One or more shutter panels are configured for fitting within the frame assembly when the frame assembly is secured to the building around a window or door opening.

The shutter panel may be secured by hinges or locks with sliding pins and easily put up or taken down in case of a hurricane or tornado. The shutter panels may be solid panels or Bermuda-style panels with angled slats.

### BRIEF DESCRIPTION OF THE DRAWINGS

Reference will now be made to the drawings, wherein like parts are designated by like numerals, and wherein

FIG. 1 is a perspective view of the storm shutter assembly of the first embodiment of the present invention.

FIG. 2 is a cross-sectional view taken along lines A-A of FIG. 1.

FIG. 3 is a cross-sectional view taken along lines B-B of FIG. 1.

FIG. 4 is an exploded view of the storm shutter assembly according to the first embodiment of the present invention.

FIG. 5 is a detail view illustrating a hinge unit of the storm shutter assembly of the first embodiment of the present invention.

FIG. 6 is a perspective view of the storm shutter assembly of the second embodiment of the present invention as seen from the outside.

FIG. 7 is a side view of the panel member of the second embodiment of the present invention frame assembly of the present invention.

FIG. 8 is a plan view of the third embodiment of the storm shutter assembly of the present invention.

FIG. 9 is a perspective view of the storm shutter assembly according to the fourth embodiment of the present invention.

FIG. 10 is an inside view of the storm shutter assembly according to the fourth embodiment of the present invention.

FIG. 11 illustrates steps of installing the storm shutter assembly of the first embodiment of this invention.

FIG. 12 illustrates steps of installing the storm shutter assembly of the second embodiment of this invention.

FIG. 13 illustrates steps of installing the storm shutter assembly of the fourth embodiment of this invention.

### DETAIL DESCRIPTION OF THE INVENTION

Turning now to the drawings in more detail, numeral 10 designates the storm shutter assembly of the first embodiment of the instant invention. The storm shutter assembly 10 comprises a frame assembly, which includes a plurality of elongated bodies defining frame members. The frame members include a top frame member 12, a bottom frame member 14, a first side frame member 16, and a second side frame member 18. The ends of the frame members are mitered so as to form a rectangular frame when installed around a window or other opening in a building.

The top frame member 12 has a tongue 20, 21 formed on each of its opposing ends. Similarly, the bottom frame member 14 has a tongue 22, 23 formed on each of its opposing ends. The first side frame member 16 has a groove 24, 25 formed in each of its opposing ends, and the second side frame member 18 has a groove 26, 27 formed in each of its opposing ends. When the frame members are joined together the tongues of the top and bottom frame members fit within the grooves of the side frame members.

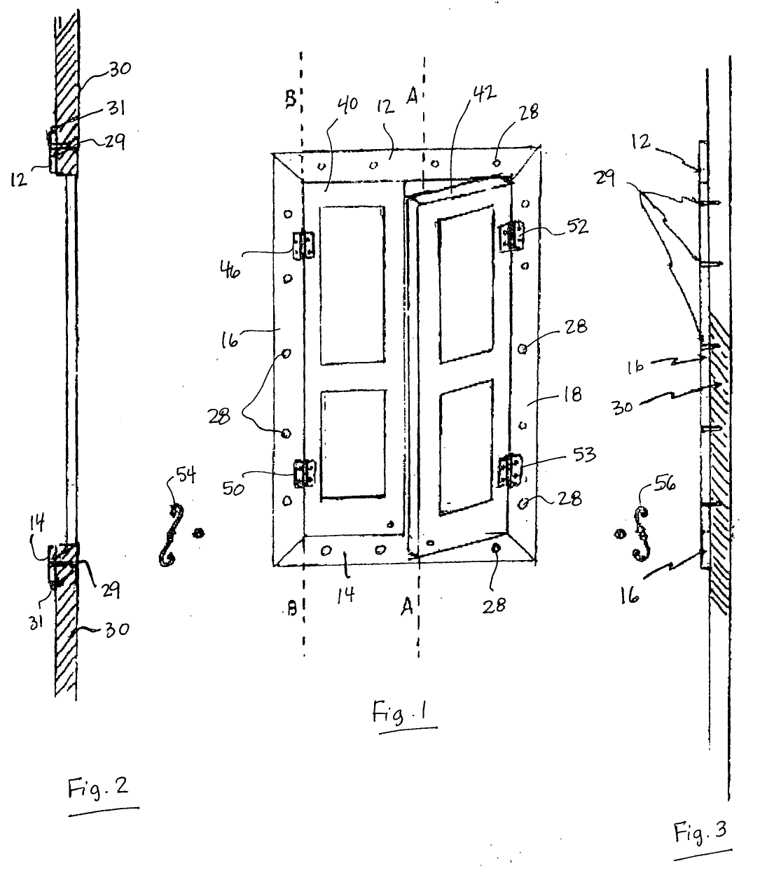

Each of the frame members is provided with a plurality of pre-drilled openings 28, each configured to receive a screw 29 that secures the frame members to the wall around a window or other opening in the building. Once installed on the building, the frame members remain positioned on the building although they can be removed if necessary. As can be seen in FIG. 2, the top frame member 12 is secured to a wall 30, and fastener screws 29 are inserted through the openings 28 into the wall 30. The bottom frame member 14 is similarly secured to the wall 30 by the screws 29. If desired a bead of caulk 31 can be used to seal the interface between the wall 30 and the frame members 12, 14.

FIG. 3 illustrates position of the side frame member 16 joined by the top frame member 12 and the bottom frame member 14. A plurality of fastener screws 29 are inserted through the side frame member 16 into the wall 30, thus securing the side frame member 16 on the wall 30. The second side frame member 18 can be mounted on the wall 30 in a similar manner.

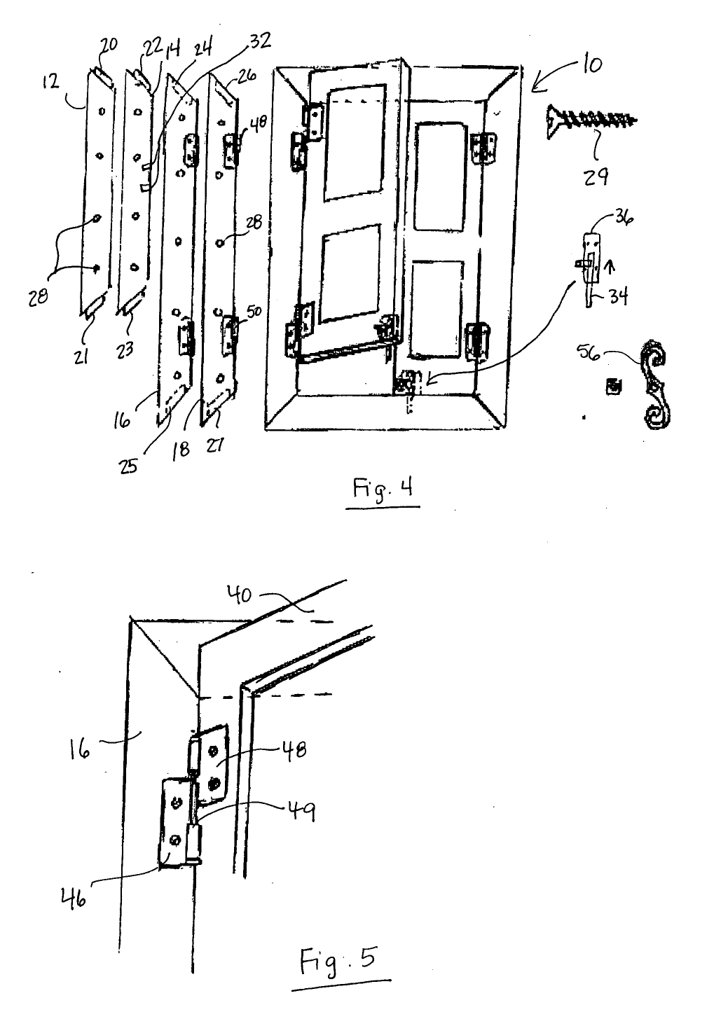

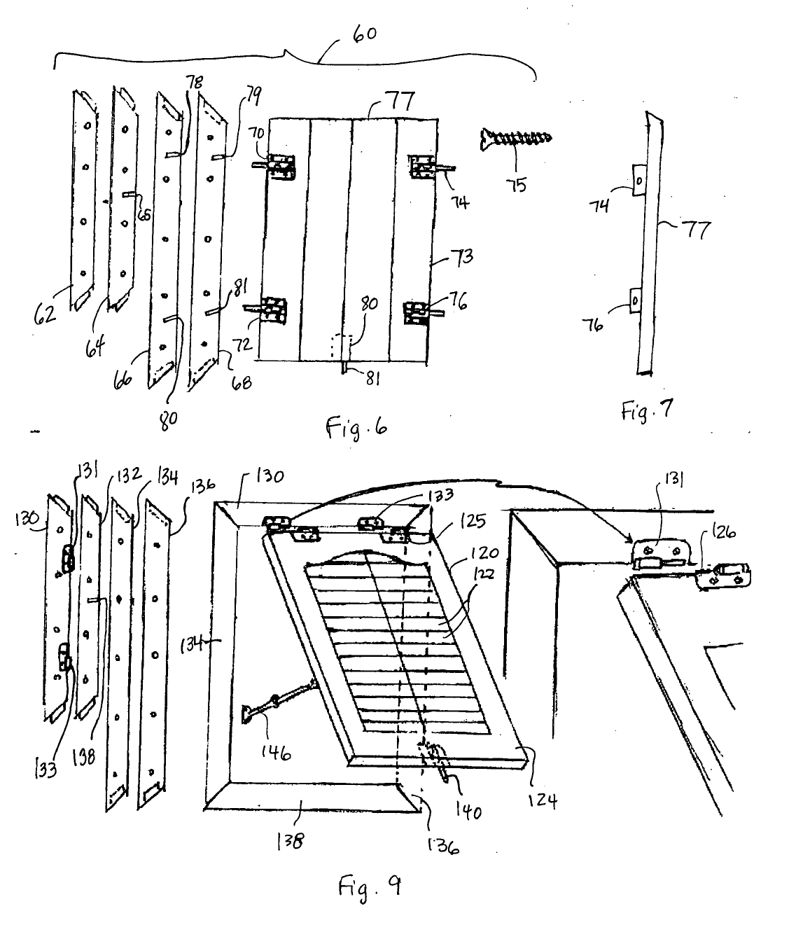

The bottom frame member 14 is further provided with a pair of slots 32, each of which is configured to receive a pin 34 of a lock 36 (FIG. 4). The locks 36 are secured on lower portions of out-swinging solid shutter panels 40, 42. Each lock 36 has a sliding pin 34, which can be lifted upwardly to release the lock and allow the shutter to be open. To close the shutter, the pin 34 is dropped into one of the slots 32 and pivoted into a locked position shown on the right in FIG. 4. The locks 36 are accessible from interior of the building so that the user can quickly close and lock the shutters in case of emergency.

The shutter panels 40, 42 are hingedly secured on the side frame members 16 and 18, respectively. A first hinge plate 46 is secured to the first side frame member 16, and a second hinge plate 48 is secured to the side of the shutter 40 in alignment with the first hinge plate 46. A hinge pin 49 connects the hinge plates 46, 48, allowing a limited pivotal movement of the shutter 40 between an open and a closed position. A bottom hinge set 50 stabilizes position of the shutter 40 with the first side frame member 16. The shutter 42 is similarly pivotally secured to the second frame member 18 using hinge sets 52 and 53.

The shutters 40, 42 can be left on the building at all times, especially during hurricane seasons. A pair of keepers 54, 56 is provided for retaining the shutters 40, 42 in an open position, when desired. However, a homeowner can easily remove the shutters 40, 42 by lifting them of the hinges and store the shutters in a convenient location.

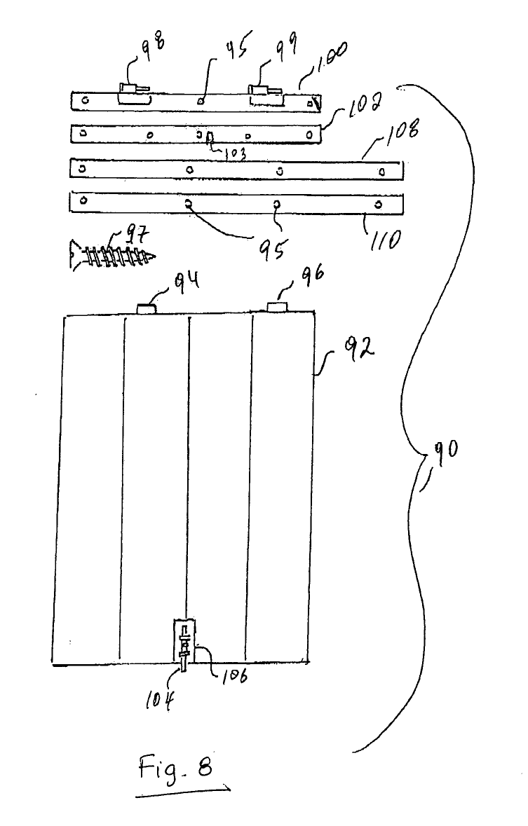

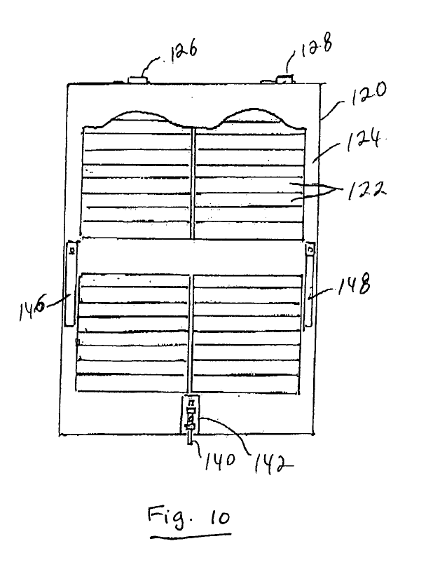

Turning now to FIGS. 6 and 7, the second embodiment 60 of the present invention is seen comprising elongated frame members 62, 64, 66, and 68, and a single shutter panel 70. The top frame member 62 is similar to the top frame member 12; the bottom frame member 64 is similar to the bottom frame member 14 except there is a single slot 65 in the bottom frame member 64. The side frame members 66, 68 are similarly provided with end grooves for receiving tongues formed on the ends of the top and bottom frame members 62, 64.

A pair of spaced-apart sliding locks 70, 72 is secured to the first side 71 of the solid shutter panel 77. A similar pair of sliding locks 74, 76 is secured to the second side 73 of the shutter panel 70. The locks 70, 72, 74 and 76 are similar to the lock 36 that is each of these locks has a similar sliding pin that moves outwardly of the locking plates to secure position of the shutter panel 70 in the building opening. To this end, the side frame members 66 and 68 are each provided with a pair of spaced-apart slots 768, 79, 80, and 81 for receiving of the pins of the locks 70, 72, 74, and 76 therein.

A central lock 80, similar to the locks 70, 72 is positioned on the inside surface of the panel 70. The pin 81 of the lock 80 is configured for engaging within the slot 65 of the bottom frame member 64 when the panel 70 is secured on a covering position over a window or other opening in the building.

FIG. 8 illustrates the third embodiment of the shutter assembly of the present invention, which is designated by numeral 90. In this embodiment, a single solid panel 92 is hinged at the top with the hinges 94, 96 that engage with the hinge plates 98, 99 of the top frame member 100. The bottom frame member 102 is provided with a slot 103 for receiving the sliding pin 104 of the lock 106. The lock 106 is secured adjacent the lower part of the shutter panel 92.

The side frame members 108 and 110, as well as top frame member 100 and the bottom frame member 102 are provided with a plurality of openings for receiving fastening screws 97. It will be understood that although only one such fastening screw is shown in the drawings of different embodiments, a kit containing the shutter assembly according to any of the embodiments of this invention will have the necessary number of fastening screws incorporated therein.

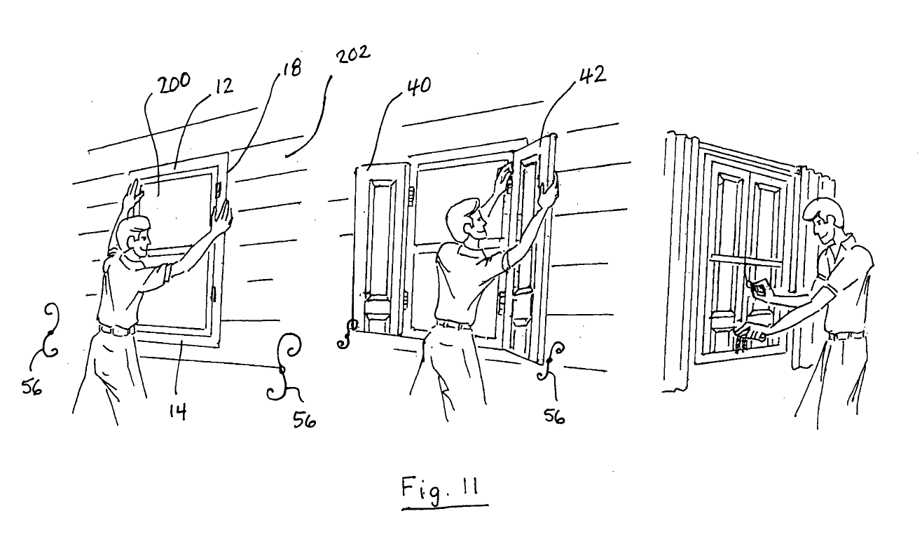

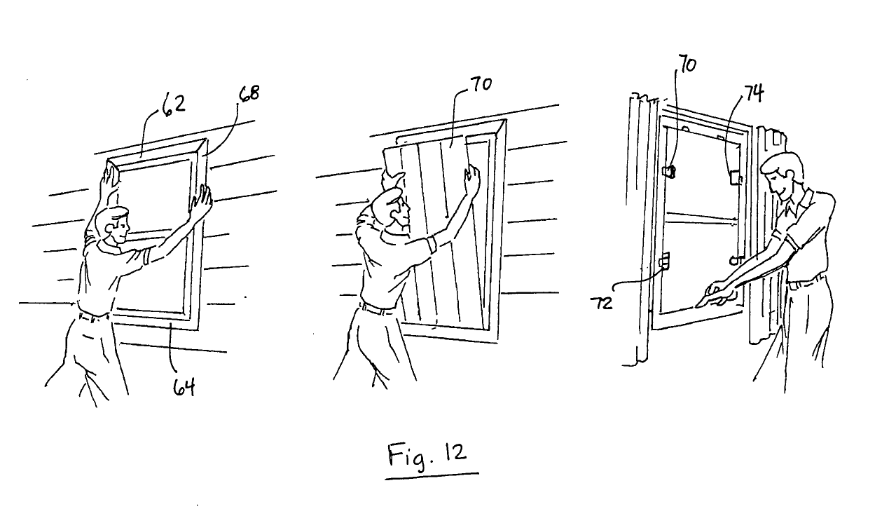

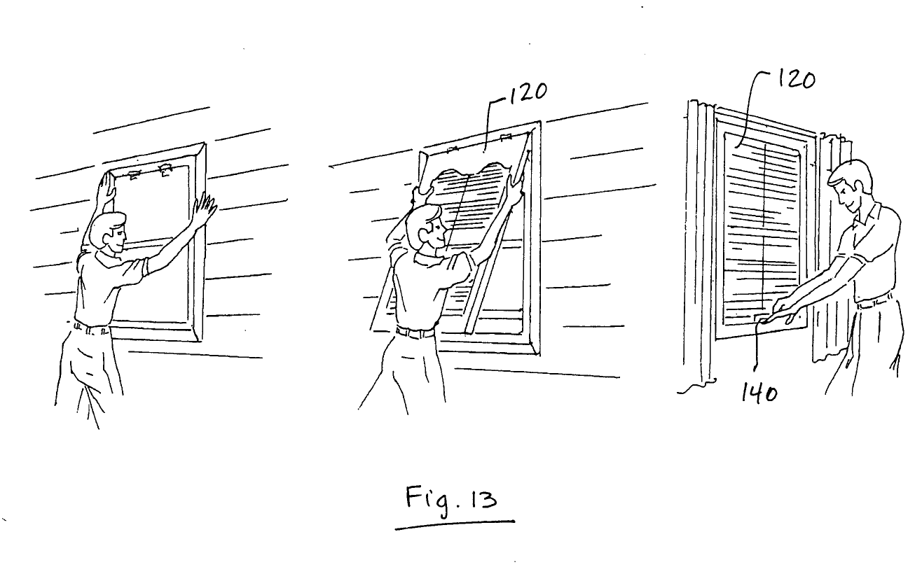

FIGS. 9 and 10 illustrate the fourth embodiment of the shutter assembly, wherein the out-swinging shutter is formed as Bermuda-style shutter panel 120. Such panels are conventionally formed with a plurality of angled slats 122, which are fitted into a surrounding frame 124. The Bermuda shutter frames 124 may be decorated with fanciful curved lines, as shown in FIGS. 9 and 10 to enhance their aesthetic appearance.

Traditionally, Bermuda shutters are pivoted at the top. To this end the present invention provides hinge plates 126, 128 at the top of the panel frame 124. A top frame member 130 has the matching hinge plates 131, 133 for securing the panel 120 with the storm shutter frame. The bottom frame member 132 is provided with a slot 138, which is configured to receive a pin 140 of the lock 142 when the shutter panel 120 is closed.

To maintain the shutter panel 120 is an open position, the present invention provides for a pair of extension arms 146, 148, which extend outwardly, as shown in FIG. 9 to partially pivot the shutter panel 120, and fold down, as shown in FIG. 10, when the shutter panel in pivoted down, into a closed position.

FIG. 11 illustrates a method of installing the storm shutter assembly according to the first embodiment of the invention. While outside, a user first secures all frame members 12, 14, 16, and 18 in a surrounding relationship to a window opening 200 of a building 202. The user then hangs the shutters 40, 42 using the provided hinges. The shutters may be left open, secured by the keepers 56 until a hurricane or tornado warning is received. When such event occurs, the user releases the shutter panels 40, 42 and secures the lock 36 from the inside of the house 202.

FIG. 11 illustrates the manner of installation of the solid shutter panel 70. While outside, the user secures the frame members 62, 64, 66, and 68 using the provided fastener screws 75. The user then inserts the shutter panel 70 into the opening and moves inside to latch the locks 70, 72, 74 and 76 from the inside the house. The lock 80 can also be secured from the house interior.

FIG. 13 illustrates a process of installation of Bermuda shutters 120. The user first works outside installing and securing the frame members 130, 132, 134, and 136. The user then secures the hinges 131, 126 and 133, 125 at the top of the shutter panel 120 and the top frame member 130. When the emergency is approaching, the user locks the shutter panel 120 using the lock 140 from the interior of the house. Once the danger passes the shutters can be opened to admit air and sunlight.

The storm shutter assembly of this invention can serve as security shutters as well. The frame members and the shutter panels may be formed from strong non-corrosive material, such as wood, aluminum and the like, capable of withstanding strong winds and impact from flying debris.

The kit format is user friendly, easy to assembly, and provides a window covering that can be very quickly installed by inexperienced do-it-yourselfers. A set of instructions is included in the kit to provide step-by-step directions as to how to attach the frame member to a masonry wall or wooden structure or other siding such that the siding is not damaged. The shutter panels may remain positioned on the building and can be held in an open position as necessary.

As an alternative embodiment, the storm shutter assembly may have the frame members pre-assembled in a factory. The user can then select the shutter kit depending on the size of the windows existing on the structure. The remaining steps can be performed by inexperienced user when attaching the frame to the outside of a house and then hanging the shutter panels using the attached hinges. The frame members of the assembly do not have to have precise fit for the building opening. A somewhat larger frame for the storm shutters will work as well.

Many other changes and modifications can be made in the present invention without departing from the spirit thereof. I, therefore, pray that my rights to the present invention be limited only by the scope of the appended claims.

I claim:

1. A storm shutter assembly for a building structure, comprising:
a frame assembly configured for securing around an opening in the building structure, said frame assembly comprising a top frame member, a bottom frame member coupled to the first frame member, a first side frame member coupled to the top frame member and the second frame member, and a second side frame member coupled to the top frame member and the second frame member opposite said first side frame member; and
at least one shutter panel configured to be detachably secured within said frame assembly.

2. The apparatus of claim 1, further comprising a hinge assembly coupled to said frame assembly and said at least one shutter panel.

3. The apparatus of claim 2, wherein said assembly comprises a first and a second out-swinging shutter panels.

4. The apparatus of claim 3, wherein said hinge assembly comprises a plurality of hinge units secured between the first side frame member and the first shutter panel, and a plurality of hinge units secured between the second side frame member and the second shutter panel.

5. The apparatus of claim 2, wherein said hinge assembly comprises a plurality of hinge units secured between the top frame member and said at least one shutter panel.

6. The apparatus of claim 2, wherein each of said top frame member, the bottom frame member, the first side frame member and the second side frame member comprises an elongated body provided with a plurality of spaced-apart openings, each opening being configured to receive a fastener element therethrough for attachment to the building structure.

7. The apparatus of claim 2, wherein opposing ends of the frame members are mitered and configured to form a rectangular frame when installed around the opening in the building structure.

8. The apparatus of claim 2, wherein each of said top frame member and said bottom frame member has opposing ends and wherein a tongue is formed on each of said opposing ends.

9. The apparatus of claim 9, wherein each of said first side frame member and said second side frame member has opposing ends and wherein a groove is formed in each of the opposing ends, said grooves being configured to receive tongues of the top frame member and the bottom frame member.

10. The apparatus of claim 2, further comprising a lock with a sliding pin secured to a bottom portion of said at least one shutter panel.

11. The apparatus of claim 10, wherein a slot is formed in said bottom frame member, said slot being configured to receive the sliding pin therein, said lock and pin being configured to lock said at least one shutter panel from interior of the building structure.

12. The apparatus of claim 1, wherein said at least one shutter panel has an interior surface, said interior surface carries a plurality of locks with sliding pins configured for locking position of said at least one shutter panel from interior of the building structure.

13. The apparatus of claim 1, wherein said at least one shutter panel comprises a solid body.

14. The apparatus of claim 1, wherein said at least one shutter panel comprises a Bermuda-style shutter panel.

15. The apparatus of claim 15, wherein said at least one shutter panel comprises an interior surface, and wherein an extension arm is secured to said interior surface, said extension arm being configured for retaining said at least one shutter panel in an open position.

16. A storm shutter assembly for a building structure, comprising:
a frame assembly configured for securing around an opening in the building structure, said frame assembly comprising a top frame member, a bottom frame member coupled to the first frame member, a first side frame member coupled to the top frame member and the second frame member, and a second side frame member coupled to the top frame member and the second frame member opposite said first side frame member;
at least one shutter panel configured to be detachably secured within said frame assembly; and
a hinge assembly coupled to said frame assembly and said at least one shutter panel.

17. The apparatus of claim 16, wherein said assembly comprises a first and a second out-swinging shutter panels.

18. The apparatus of claim 17, wherein said hinge assembly comprises a plurality of hinge units secured between the first side frame member and the first shutter panel, and a plurality of hinge units secured between the second side frame member and the second shutter panel.

19. The apparatus of claim 16, wherein each of said top frame member, said bottom frame member, the first side frame member and the second side frame member comprises an elongated body provided with a plurality of spaced-apart openings, each opening being configured to receive a fastener element therethrough for attachment to the building structure.

20. The apparatus of claim 16, wherein each of said top frame member and said bottom frame member has opposing ends and wherein an outwardly extending tongue is formed on each of said opposing ends, wherein each of said first side frame member and said second side frame member has opposing ends and wherein a groove is formed in each of the opposing ends, said grooves being configured to receive tongues of the top frame member and the bottom frame member.

21. The apparatus of claim 20, wherein opposing ends of the frame members are mitered and configured to form a rectangular frame when installed around the opening in the building structure.

22. The apparatus of claim 16, wherein said at least one shutter panel comprises an interior surface, and wherein a lock with a sliding pin is secured to a bottom portion of said interior surface of the at least one shutter panel.

23. The apparatus of claim 22, wherein a slot is formed in said bottom frame member, said slot being configured to receive the sliding pin therein, said lock and pin being configured to lock said at least one shutter panel from interior of the building structure.

24. The apparatus of claim 16, wherein said at least one shutter panel comprises a solid body.

25. The apparatus of claim 16, wherein said at least one shutter panel comprises a Bermuda-style shutter panel having a plurality of angled slats.

26. The apparatus of claim 25, wherein said at least one shutter panel comprises an interior surface, and wherein an extension arm is secured to said interior surface, said extension arm being configured for retaining said at least one shutter panel in an open position.
